(19) United States
(12) Patent Application Publication
(10) Pub. No.: US 2007/0226454 A1
(43) Pub. Date: Sep. 27, 2007

(54) Highly scalable MIMD machine for java and .net processing

(76) Inventors: Marius Stoian, Vrancea (RO); Gheorghe Stefan, Nashua, NH (US)

Correspondence Address: MCCORMICK, PAULDING & HUBER LLP, CITY PLACE II, 185 ASYLUM STREET, HARTFORD, CT, 06103, US

(21) Appl. No.: 11/365,723

(22) Filed: Mar. 1, 2006

(51) Int. Cl. G06F 15/00

(52) U.S. Cl. 712/10

(57) ABSTRACT

An MIMD processor for Java and Net processing includes a plurality of “half-processors,” separate execution units, and memory caches. Each half-processor is an MIMD processing element having resources for instruction fetch and decode and for instruction stream context management, but excluding execution resources. In other words, the execution resources are removed from the processing elements (resulting in the half-processors) and provided as separate elements for being shared by all the half-processors. The execution units, memory caches, and half-processors are operably connected by two interconnection networks that use a priority-based communications scheme for administering shared access to the execution units and memory caches by the half-processors. The MIMD machine uses a Java and/or .Net instruction set and is capable of running both separate and combined Java and .Net instructions. An instruction stream management unit may be connected to the interconnection networks for controlling communications between the half-processors and shared resources.

### FIELD OF THE INVENTION

The present invention relates to processing architectures and instruction processing for electrical computers and digital data processing systems and, more particularly, to MIMD array processors.

### BACKGROUND OF THE INVENTION

With many commercial computing applications, most of the hardware/processor resources remain unused during computations. This happens because of horizontal and vertical wasting. Vertical wasting occurs, e.g., when a processor unit capable of executing several disjunctive functions is only used for one function in each cycle. Here, the hardware resources owned by the other functions are not used, resulting in poor processor space utilization. In the case of horizontal wasting, processor resources are underutilized in terms of operand length, e.g., using a 32-bit integer unit for operations on 8-bit operands. This results in poor time utilization, since an 8-bit integer unit would execute an 8-bit operation must faster than would a 32-bit integer unit. For small resources, horizontal and vertical wasting can be ignored, but a low degree of utilization for large and expensive resources (like memory caches) contributes to an overall inefficiency for the entire microchip/processor.

Sharing resources wherever possible in a processor can increase overall performance considerably. For example, it is known that the cache in a processor can comprise more than 50% of the total area of the chip. If by increasing resource sharing the utilization degree of the cache doubles, the processor will run with the same performance as when the cache size is doubled.

For increasing the degree of resource sharing and overall computational efficiency, some processors are based on MIMD (multiple instruction multiple data) designs. MIMD is a type of parallel computing architecture where many functional units perform different operations on different data. MIMD machines typically contain multiple processing elements and multiple shared resources (e.g., memory caches and I/O), all connected (directly or indirectly) via an interconnection network. Each processing unit typically includes an execution unit (e.g., control unit, registers, ALU, floating point unit) integral with other resources such as storage/memory and instruction decoders. Because data has to be shared/transmitted between the multiple processing elements and shared resources through the interconnection network, the degree to which the MIMD design improves processor resource sharing and efficiency will depend on the nature and configuration of the processing elements and shared resources, as well as the manner in which they intercommunicate.

### SUMMARY OF THE INVENTION

An embodiment of the present invention relates to an MIMD machine/microprocessor for Java- and .Net (“dot net”)-based processing. (Java and Net are programming languages that provide “built in” support for multithreading, i.e., for processing multiple sequences of instructions at the same time.) For example, the processor could be used as a processor or microcontroller in an embedded real-time system. Instead of having multiple integrated processing elements, the MIMD machine includes a plurality of “half-processors” and a plurality of separate execution units. Thus, each half-processor is an MIMD processing element but excluding execution resources, i.e., the execution unit/resources are removed and provided as separate elements. The half-processors each include resources for instruction fetch and decode, and for instruction stream context management. By “separating” the execution resources from the remainder of the processing elements (i.e., by providing separate half-processors and execution units), the execution resources can be shared by all the half-processors. This results in an important increase in the degree of resource utilization, which in turn results in an overall increase in performance.

The MIMD machine further includes a plurality of memory caches. The execution units and memory caches are shared between all the half-processors using two interconnection networks and a priority based communications scheme. The two interconnection networks increase the utilization degree of the shared resources, resulting in a higher overall performance. Also, depending on the application running, this architecture can be scaled with a very fine grain in terms of number of thread slots (which depends on the degree of parallelism in the running application), the number and type of execution units (which depends on the type of computation required by the application), and the cache and stack cache size (both of which depend on target performance). As should be appreciated, this architecture thereby provides a high degree of flexibility. Also, the MIMD machine is able to process multiple instruction streams that can be easily associated with threads at the software level.

The MIMD machine uses a “Java/.Net” instruction set, by which it is meant that the MIMD machine uses a Java and/or Net instruction set and is capable of running both separate and combined Java and .Net instructions. Most of the instructions are directly executed using hardware resources. The Java/.Net instruction set results in an even higher level of processing flexibility, and provides another layer of scalability. In particular, using a platform-independent instruction set like Java and/or Net is advantageous because of the virtualization of hardware resources. The processor architecture can be scaled into a large range of products that are capable of running the same applications (e.g., software programs), with the overall performance level depending on allocated resources. For example, because the Java Virtual Machine Specification uses a stack instead of a register file, this helps with scaling the hardware resources allocated for the operands stack, depending on the performance/costs of the target products.

### BRIEF DESCRIPTION OF THE DRAWINGS

The present invention will be better understood from reading the following description of non-limiting embodiments, with reference to the attached drawings, wherein below:

FIG. 1 is a schematic diagram of an embodiment of an MIMD machine/processor for Java and .Net processing according to the present invention;

FIG. 2 is a schematic diagram of a half-processor portion of the MIMD processor;

FIG. 3 is a schematic diagram of a decode and folding unit portion of the half-processor;

FIG. 4 is a schematic diagram of a decode unit portion of the decode and folding unit;

FIG. 5 is a schematic diagram of a folding unit portion of the decode and folding unit;

FIGS. 6A-6C are tables showing various classifications and rules used for folding microinstructions by the folding unit;

FIG. 7 is a schematic diagram of a stream management unit portion of the processor; and

FIG. 8 is a schematic diagram of the control of an interconnection network portion of the processor.

### DETAILED DESCRIPTION

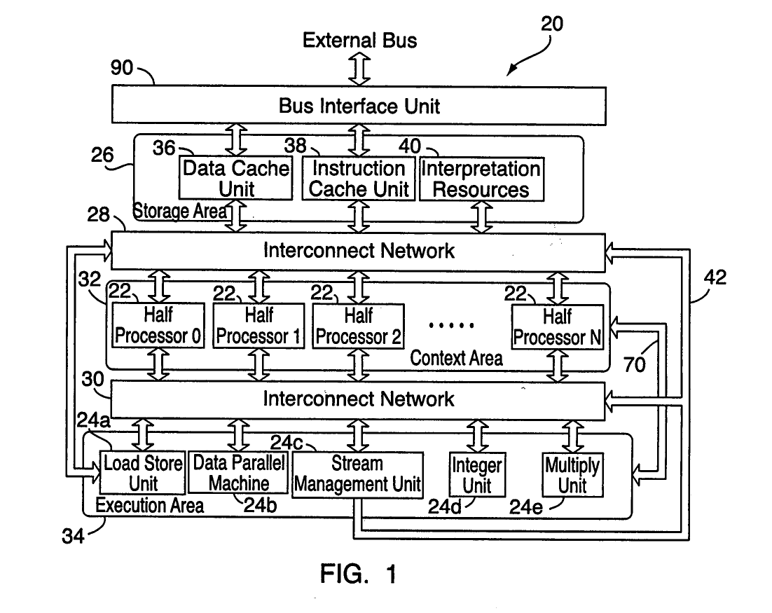

With reference to FIGS. 1-7, an embodiment of the present invention relates to an MIMD machine or processor 20 for Java- and Net-based processing. The MIMD processor 20 includes a plurality of half-processors 22 and a plurality of execution units 24a-24e separate from the half-processors 22. By “half-processor” 22, it is meant an MIMD processing element having certain processing resources such as instruction fetch, instruction decode, and context management, but that excludes execution units and other execution resources. (Execution units are hardware resources that perform calculations called for by a program/application running on or using the processor, such as floating point units and arithmetic logic units.) By providing separate half-processors 22 and execution units 24a-24e, the processor's execution resources can be shared by all the half-processors 22. As noted above, this results in an increase in the degree of resource utilization, which in turn results in an overall increase in performance.

The MIMD processor 20 further includes a storage area 26. First and second interconnection networks 28, 30 operably selectively interconnect the storage area 26, the execution units 24a-24e, and the half-processors 22. The execution and storage resources are shared by all the half-processors 22, with concurrent requests for access to the same shared resource by multiple half-processors 22 being controlled by a priority based communications scheme in place on the interconnection networks 28, 30. The two interconnection networks increase the utilization degree of the shared resources, resulting in a higher overall performance. Also, depending on the application/program running on the processor, this architecture can be scaled with a very fine grain in terms of number of thread slots (which depends on the degree of parallelism in the running application), the number and type of execution units (which depends on the type of computation required by the application), and the cache and stack cache size (both of which typically depend on target performance).

The MIMD processor 20 can be characterized as having three main areas, the storage area 26, a context area 32, and an execution area 34. The context area 32 contains the half-processors 22 arranged, e.g., in an array. The number of half-processors 22 provided depends on the needs of the application/program using the processor 20. The storage area 26 contains expensive shared resources such as a data cache 36 for storing data locally, an instruction cache 38 for storing program instructions locally (e.g., the instruction cache may contain a subset of the program instructions stored elsewhere in RAM or other memory), and interpretation resources 40 (e.g., memory, lookup tables, decoders, or the like for interpreting complex instructions). These shared resources can be scaled (in terms of modifying the size of the caches) depending on the needs of the application. The execution area 34 contains the execution units 24a-24e, which may include a load store unit 24a, a data parallel machine 24b, an integer unit 24d, and a multiply unit 24e, among others. The execution units 24a-24e can be scaled in terms of number and type (e.g., different numbers or types of execution units), again, depending on the needs of the application. The half-processors 22 share the resources in the storage area 26 and execution area 34, e.g., they share the cache units 36, 38, the interpretation resources 40, and the execution units 24a-24e (collectively, “shared resources”).

Each interconnection network 28, 30 is a point-to-multipoint connector implemented using a network of multiplexers 44 (see FIG. 8) which can be controlled to make a connection between each half-processor 22 in the context area 32 and each shared resource in the storage area 26 and execution area 34. The first interconnection network 28 is used by the half-processors 22 in the context area 32 for accessing the shared resources in the storage area 26. The second interconnection network 30 is used by the half-processors 22 for accessing shared resources in the execution area 34. For each shared resource, concurrent requests for access from multiple half-processors 22 are controlled by the communications priority or election mechanism 46 in place on the processor 20. Thus, when more than one half-processor 22 requires access to a target shared resource, the priority mechanism 46 selects a particular half-processor 22 for gaining access to the target shared resource. The priority mechanism 46 may include, and/or work in conjunction with, a stream management unit 24c (located in the execution area 24 or otherwise). In operation, instruction streams running on the half-processors 22 are each assigned a priority level, typically by the application running on the processor or some portion thereof (e.g., software thread). The stream management unit 24c keeps track of the priority levels, and sends a “currentPrivilegedStrem” signal 42 to the interconnection networks 28, indicating which half-processor 22 is running the instruction stream with the highest priority level. If the half-processor 22 indicated by the currentPrivilegedStream signal 42 has a valid request for accessing the target shared resource, then it is connected to the target shared resource. If the half-processor 22 indicated by the currentPrivilegedStream signal 42 does not have a valid request for accessing the target shared resource, then the priority mechanism 46 arbitrarily selects another half-processor 22 with a valid request for accessing the target shared resource.

The interconnection networks 28, 30 are believed to be the most efficient way to connect the array of half-processors 22 to the shared storage and execution resources 26, 34. Further examples of ways in which to connect the half-processors 22 to the shared resources can be derived from U.S. Pat. No. 6,560,629 entitled “MULTI-THREAD PROCESSING” to Harris, which is incorporated by reference herein in its entirely.

The processor 20 may use a “Java/.Net” instruction set, by which it is meant a Java and/or .Net instruction set including the capability of running both separate and combined Java and .Net instructions. In such a case, the half-processors 22 will be configured to support (process) individual Java/.Net instruction streams, and possibly including hardware support for fetching, decoding, and executing a Java/.Net instruction stream. Typically, each instruction stream will be associated with a Java/.Net thread in the application or software program running on or otherwise utilizing the processor 20.

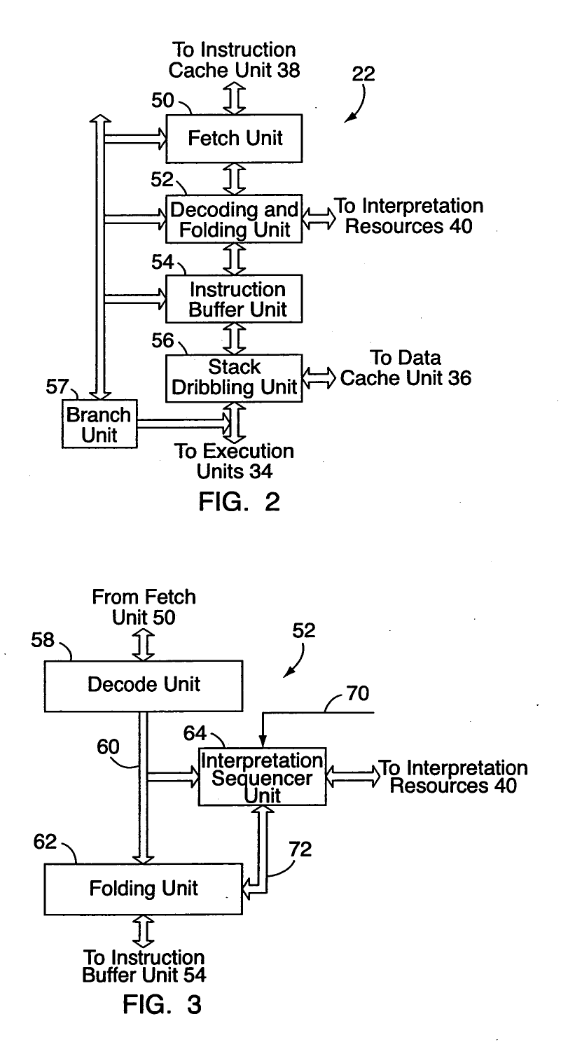

FIG. 2 shows one of the half-processors 22 in more detail. The half-processor 22 includes a fetch unit 50 used to fetch instructions from the instruction cache unit 38 when connected thereto. A decode and folding unit 52 is interfaced with the fetch unit 50, and with the interpretation resources 40 (in a controlled manner through the first interconnection network 28). The decode and folding unit 52 is provided for decoding and folding multiple instructions into a single instruction (e.g., several commonly encountered instructions folded into a single RISC-like instruction). The fetch unit 50 typically fetches sixteen bytes at a time from the instruction cache unit 38 and passes them to the decode and folding unit 52. An instruction buffer unit 52 is interfaced with the decode and folding unit 52 for temporarily storing several microinstructions that are ready to be issued. Additionally, a stack dribbling unit 56 is interfaced with the instruction buffer unit 54 and with the data cache unit 36 (through the first interconnection network 28) for providing fast access to the stack operands. In particular, the stack dribbling unit 56 may cache the local variables array, method frame, and/or stack operands. A suitable stack dribbling unit 56 is disclosed in U.S. Pat. No. 6,021,469 entitled “HARDWARE VIRTUAL MACHINE INSTRUCTION PROCESSOR” to Tremblay et al., hereby incorporated by reference herein in its entirety. Finally, the half-processor 22 further includes a branch unit 57 interfaced with the fetch unit 50, decoding and folding unit 52, and instruction buffer unit 54 for handling application/program branch instructions. The branch unit 57 may be configured to attempt to execute branches (and remove them from the instruction stream) as early as possible to maximize performance.

The decode and folding unit 52 is shown in FIG. 3. The unit 52 includes a decode unit 58 which decodes up to five bytes at a time from the fetch unit 52 for generating microinstructions (e.g., instructions in a format suitable for internal use by the processor 20 and/or half-processor 22). The decode unit 58 sends the resultant microinstructions through a bus/connection 60 to a folding unit 62 and to an interpretation sequencer unit 64. The interpretation sequencer unit 64 is operably connected to the folding unit 62 and to the interpretation resources 40.

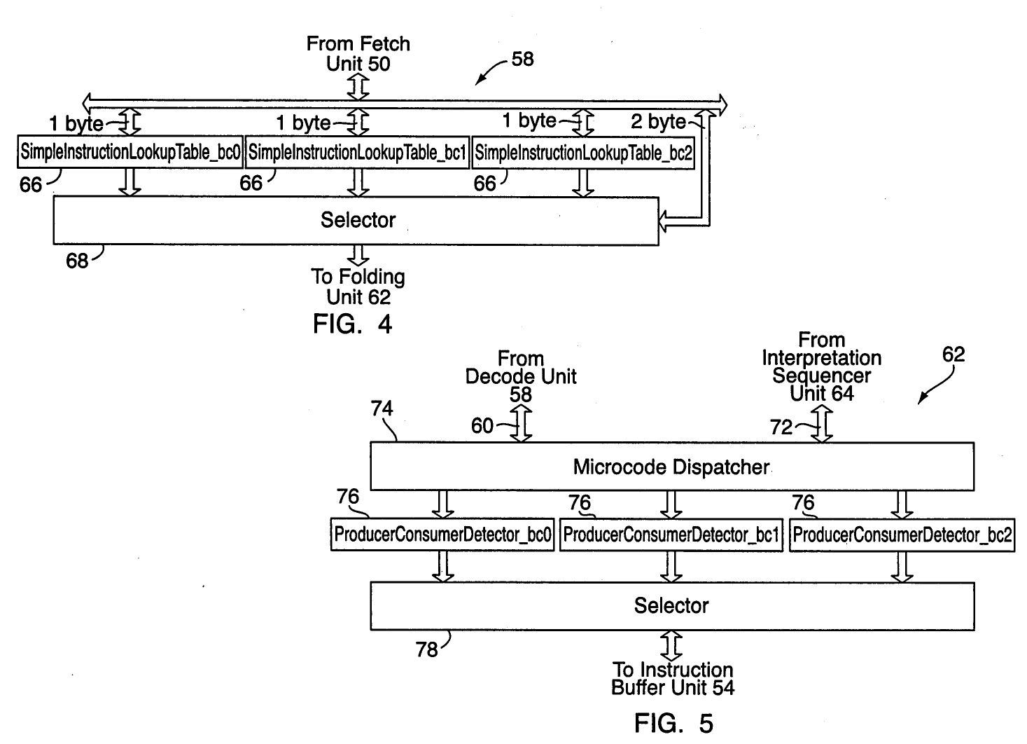

The decode unit 58, shown in FIG. 4, has at least three simple instruction lookup tables 66 for decoding up to five bytes at a time from the fetch unit 50. The lookup tables 66 are configured to decode the most frequent and/or simple instructions present in the instruction stream(s) running on the half-processor. The peak performance of the decode unit 58 is five bytes (or three instructions) per clock cycle. The bus 60 has three different paths (one for each decoded instruction) for the resultant microinstructions. A selector 68 arranges the microinstructions in order, taking into account the length of the instructions. For example, if the instruction decoded by the first lookup table 66 has a length of two bytes, the result of the second lookup table 66 is replaced with the result of the last lookup table 66.

The interpretation sequencer unit 64 is configured to determine if the lookup tables 66 failed to successfully decode any of the microinstructions. This might happen, e.g., if the instruction to be decoded is complex and/or very infrequently used. In order to decode these complex and/or infrequently used instructions, the interpretation sequencer unit 64 sends a request to the interpretation resources 40. The result of this request is passed on to the folding unit 62. Also, the interpretation sequencer unit 62 handles any exceptions thrown from the execution units 24a-24e in the execution area 34. To do so, the interpretation sequencer unit 62 waits until the end of the current instruction (if any are in progress) and then executes a jump instruction to a fixed address from where the exception will be handled by the associated handler. Exceptions are transmitted over an exception bus 70.

FIG. 5 shows the folding unit 62 which receives the results from the decode unit 58 and interpretation sequencer unit 64 for purposes of composing a more complex instruction using the simple instructions. The results from the decode unit 58 (over the bus 60) contain three microinstructions, while the communication from the interpretation sequencer unit 62 may contain a single microinstruction. In particular, the microinstructions carried over the bus 60 come from the decode unit 58. However, if the decode unit 58 fails to decode some of the instructions, the interpretation sequencer unit 64 “takes over” the instruction, with the resulting microinstruction being provided to the folding unit 62 over a line or bus 72.

The folding unit 62 includes a microcode dispatcher 74, which has the role of combining the microinstructions from the decode unit 58 and the microinstruction(s) from the interpretation sequencer unit 64. The resultant microinstructions are processed by an array of “ProducerConsumerDetector” units 76. The folding operation involves combining two or three decoded microinstructions into a single decoded microinstruction. The folding rules are based on the operations that are performed by each of the two or three microinstructions relative to the operands stack. The ProducerConsumerDetector units 76 indicate the kinds of operations that are performed by each microinstruction on the operands stack.

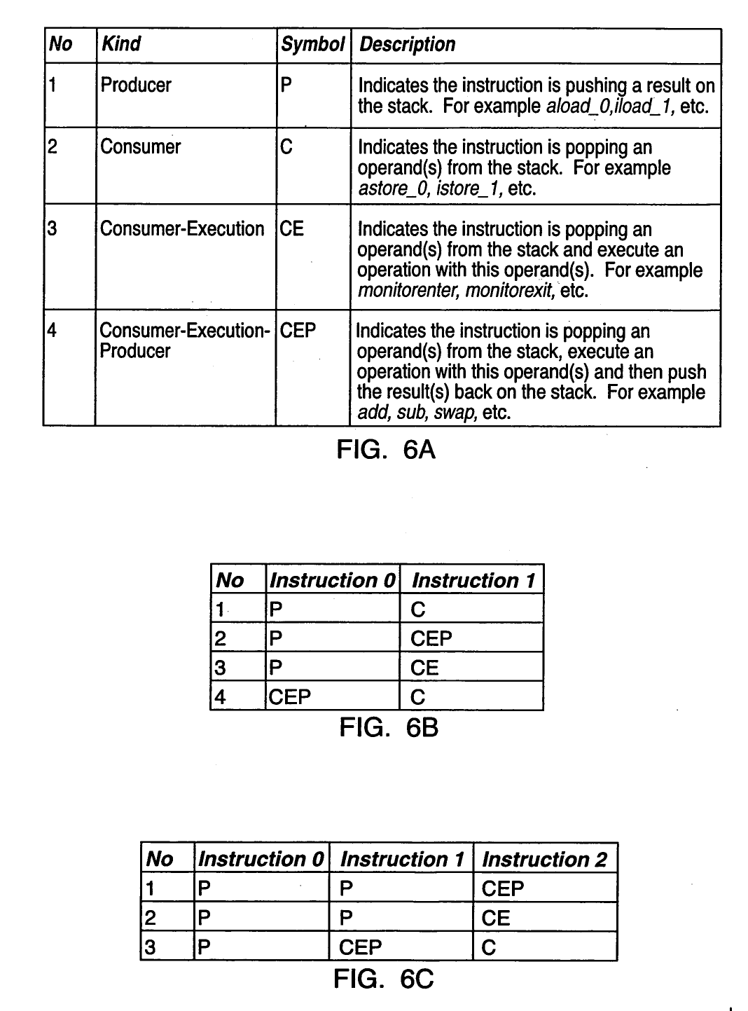

The table in FIG. 6A shows the classifications made by the ProducerConsumerDetector units 76. Based on these classifications and using a set of two rules (indicated in the tables in FIGS. 6B and 6C), a selector 78 interfaced with the ProducerConsumerDetector units 76 can fold one microinstruction (no folding), two microinstructions, or three microinstructions. In particular, FIG. 6B shows the valid combinations of two microinstructions that can be folded into a single microinstruction, while FIG. 6C shows the valid combinations of three microinstructions that can be folded into a single microinstruction.

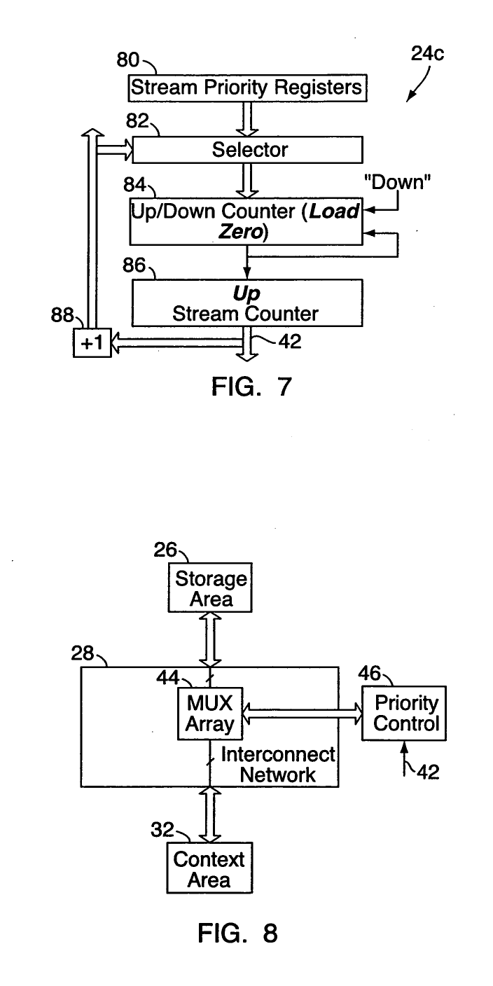

FIG. 7 shows the stream management unit 24c, which is used to control synchronization between instruction streams. The output of the stream management unit (the currentPrivilegedStream signal 42) is provided to the two interconnection networks 28, 30 for implementing the shared access priority mechanism based on stream priorities. The stream management unit 24c has a set of stream priority registers 80 that can be programmed by the application layer with the priority assigned to each instruction stream. Each instruction stream can be assigned to a Java/.Net thread, therefore these priorities can have the same range and meaning as the Java/.Net threads. A selector 82 is connected to the registers 80, and is configured to select the priority of the current instruction stream and to multiply the priority by a constant. The resultant value (priority×constant) is loaded into an up/down counter 84, which is set to count down. When the up/down counter 84 reaches a zero value it increments a stream counter unit 86. The stream counter 86 is initialized with a zero value at reset. Based on an incrementer 88, the selector 82 feeds the up/down counter 84 with the priority of the next instruction stream. The currentPrivilegedStream signal 42 constantly identifies the instruction stream that is to be elected if there is more than one instruction stream requesting access to a shared resource. This mechanism is based on the supposition that in using a higher value for a priority of an instruction stream “A,” the currentPrivilegedStream signal 42 will indicate the instruction stream A as the stream with the higher priority for a longer period of time than an instruction stream “B” having a lower priority value. Therefore, the instruction stream A has more chances to be elected more often than instruction stream B.

Switching from one instruction set to another (for example from exclusively Java to exclusively Net) requires the replacement of the simple instruction lookup tables 66, ProducerConsumerDetector units 76, and interpretation resources 40, although these can all be configured for a Java/.Net instruction set as well.

With reference back to FIG. 1, the processor 20 may also have a bus interface unit 90 interfaced with the storage area 26 for managing communications between the processor 20 and an external bus, which may be in turn connected to other resources (I/O, main memory, mass storage, etc.)

Since certain changes may be made in the above-described highly scalable MIMD machine (processor architecture) for Java and .Net processing without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A processor comprising:
a storage area;
an execution area; and
a plurality of half-processors operably connected to the storage area and execution area through an interconnection networks for shared access of the storage area and execution area by the plurality of half-processors.

2. The processor of claim 1 wherein:
the half-processors each include hardware resources for at least one of a fetch operation, a decode operation, context management, and a stack.

3. The processor of claim 1 wherein:
the execution area comprises a plurality of separately accessible execution units; and
the storage area includes at least one of a data cache, an instruction cache, and interpretation resources.

4. The processor of claim 1 wherein:
the at least one of the data cache and instruction cache are operably connected to one interconnection network for common access by the plurality of half-processors.

5. The processor of claim 1 wherein
the processor is configured for operation using an instruction set, wherein the instruction set comprises a first subset of simple and/or frequently-used instructions and a second subset of complex and/or infrequently-used instructions;
each half-processor is configured for decoding instructions in the first subset; and
the processor is configured for decoding instructions in the second subset using at least two of said half-processors in combination.

6. The processor of claim 1 wherein:
each half-processor is configured for running an instruction stream having a priority; and
the at least two interconnection networks are configured for controlling access to the storage area and/or execution area, or sub-portion thereof, by the half-processors based on the instruction stream priorities.

7. The processor of claim 6 further comprising:
a stream management unit operably connected to the at least two interconnection networks, wherein the stream management unit is configured for tracking the instruction stream priorities and for sending at least one signal to the interconnection networks for allowing access to the storage area and/or execution area, or sub-portion thereof, by a half-processor having a higher-priority instruction stream.

8. The processor of claim 1 wherein:
the half-processors are configured for running instruction streams; and
each instruction stream is directly associated with a software thread in software utilizing the processor for operation.

9. The processor of claim 1 wherein the processor is configured for operation using a Java/.Net instruction set.

10. The processor of claim 1 wherein each half-processor is configured to run Java and/or Net instructions.

11. The processor of claim 1 wherein each half-processor is configured to run combined Java and .Net instructions.

12. A half-processor comprising:
processor hardware resources for at least one of a fetch operation, a decode operation, context management, and a stack, wherein the half-processor excludes execution units or other execution resources for performing calculations called for by a software program running on a system utilizing the half-processor.

13. The half-processor of claim 12 comprising processor hardware resources for all of the fetch operation, the decode operation, context management, and the stack.

14. The processor of claim 13 wherein the half-processor is configured to run Java and/or .Net instructions.

15. The processor of claim 14 wherein the half-processor is configured to run combined Java and .Net instructions.

16. A processor comprising:
a plurality of half-processors each having hardware resources for at least one of a fetch operation, a decode operation, context management, and a stack, said half-processors excluding execution units and other execution resources for performing calculations called for by a software program utilizing the processor.

17. The processor of claim 16 further comprising:
a storage area;
an execution area; and
at least two interconnection networks operably connecting the plurality of half-processors to the storage area and execution area for shared access of the storage area and execution area by the plurality of half-processors.

18. The processor of claim 17 wherein:
the processor is configured for operation using an instruction set, wherein the instruction set comprises a first subset of simple and/or frequently-used instructions and a second subset of complex and/or infrequently-used instructions;
each half-processor is configured for decoding instructions in the first subset; and
the processor is configured for decoding instructions in the second subset using at least two of said half-processors in combination.

19. The processor of claim 17 wherein:
each half-processor is configured for running an instruction stream having a priority; and
the at least two interconnection networks are configured for controlling access to the storage area and/or execution area, or sub-portion thereof, by the half-processors based on the instruction stream priorities.

20. The processor of claim 19 further comprising:
a stream management unit operably connected to the at least two interconnection networks, wherein the stream management unit is configured for tracking the instruction stream priorities and for sending at least one signal to the interconnection networks for allowing access to the storage area and/or execution area, or sub-portion thereof, by a half-processor having a higher-priority instruction stream.

21. A processor comprising:
a storage area including at least one of a data cache, an instruction cache, and interpretation resources;
an execution area; and
a plurality of half-processors operably connected to the storage area and execution area through at least two interconnection networks for shared access of the storage area and execution area by the plurality of half-processors, wherein each half-processor comprises hardware resources for a fetch operation, a decode operation, context management, and a stack, said half-processors excluding execution units and other execution resources for performing calculations called for by a software program utilizing the processor, wherein:
the processor is configured for operation using a Java/.Net instruction set, wherein the Java/.Net instruction set comprises a first subset of simple and/or frequently-used instructions and a second subset of complex and/or infrequently-used instructions;
each half-processor is configured for decoding instructions in the first subset; and
the processor is configured for decoding instructions in the second subset using at least two of said half-processors in combination.
